(19) United States
(12) Patent Application Publication
(10) Pub. No.: US 2014/0089376 A1
(43) Pub. Date: Mar. 27, 2014

(54) CONTROL OF APPLICATIONS INSTALLED ON A REMOTE DEVICE

(71) Applicants: John T. Caldas, Watertown, MA (US); Jeremy Debate, Boston, MA (US)

(72) Inventors: John T. Caldas, Watertown, MA (US); Jeremy Debate, Boston, MA (US)

(21) Appl. No.: 14/030,183

(22) Filed: Sep. 18, 2013

Related U.S. Application Data
(60) Provisional application No. 61/706,176, filed on Sep. 27, 2012.

(51) Int. Cl. H04L 29/08

(52) U.S. Cl. CPC H04L 67/10
USPC 709/202

(57) ABSTRACT

According to example configurations, a primary application includes code that performs a check whether an agent application is installed and/or executing on a corresponding mobile device. If the primary application determines that the agent application is currently not installed and/or currently executing on the mobile device, the primary application initiates installation and/or execution of the agent application on the mobile device potentially unbeknownst to the user of the mobile device. A network administrator communicates with the agent application on the mobile device over a persistent communication link to manage a group of applications and/or related information on the mobile device.

### RELATED APPLICATIONS

This application is related to and claims the benefit of earlier filed U.S. Provisional Patent Application Ser. No. 61/706,176 entitled “CONTROL APPLICATIONS INSTALLED ON A REMOTE DEVICE,” (Attorney Docket No. APP12-05p), filed on Sep. 27, 2012, the entire teachings of which are incorporated herein by this reference.

This application is related to earlier filed U.S. Provisional Patent Application Ser. No. 61/540,218 entitled “Multi-Party Communication Sessions via Broadcast Notification Network,” (Attorney Docket No. APP11-02p), filed on Sep. 28, 2011, the entire teachings of which are incorporated herein by this reference.

This application is related to U.S. patent application entitled “CONTROL OF A REMOTE COMPUTER DEVICE,” (Attorney Docket No. APP12-04), filed on the same day as the present application, the entire teachings of which is incorporated herein by this reference.

### BACKGROUND

Software applications are often available for retrieval over a wireless network connection. For example, via a browser application or other suitable computer resource, a user of a mobile device can browse a library of available applications and initiate installation of one or more selected applications to their handheld mobile device.

Use of one or more applications installed on a mobile device may be conditional. For example, a user may be a member of an organization. Because a user is an employee, the user may have access to a library of applications that enable the employee to more efficiently perform his or her job functions.

Employee-retrieved applications can include e-mail management applications, location-tracking applications, meeting management applications, human resource management applications, etc.

Providing an employee access to the employer's applications can be problematic because use of the applications may depend on a status of the user belonging to a respective organization. For example, when an employee of an organization is terminated, it is often desired by the organization that the user be prevented from using any of the corporate owned applications that were previously installed on the mobile device so that the employee can carry out his job. It may be desirable to remove the application from a user's mobile device subsequent to termination of the user as an employee.

Certain applications have been developed to enable so-called remote wiping of a mobile device to prevent subsequent access to the data on the device. For example, many of today's smartphones support so-called remote wipe capability. In general, a remote wipe enables a mobile device owner or support engineer to remotely erase all of the data and/or applications on the mobile device in the event that the mobile device is lost or stolen.

In accordance with conventional techniques, transmission of an appropriate command or code word from a user to the remote wipe application on the mobile device causes a respective application on the mobile device to execute the remote wipe function. Thus, after the remote wipe by a respective authorized party, all information on the mobile device is wiped away (i.e., erased). The information is no longer available for viewing or use by a party that misappropriates the mobile device.

### BRIEF DESCRIPTION OF DIFFERENT EMBODIMENTS AS DISCUSSED HEREIN

Conventional applications for remotely controlling removal of applications and/or data from a mobile device suffer from a number of deficiencies. For example, as discussed above, an employee can install different applications onto their mobile device for use during employment. A user may also install non-employer applications for their own personal use separate from their employer. Upon termination of employment, generation of a remote wipe to erase all information on the mobile device may not be desirable because such a function would remove even the user's personal applications as well. Thus, the remote wipe capability is not necessarily useful if certain applications are to be saved.

As an alternative to enabling installation of employer applications and personal applications to a single mobile device owned by the user, note that the employer may issue an extra mobile device for use by the employee during employment. In such an instance, a user may have to manage use of multiple mobile computer devices or cell phones—one mobile device issued for work and another mobile computer device purchased by the user for their own personal use. Unfortunately, issuance of an employer-owned mobile computer device is undesirable because the user must then manage use of two mobile computer devices instead of one. Also, a company does not benefit from the use of a mobile device already owned and operated by the employee. Thus, there is a benefit when an employee can use their own mobile computer device to use employer-owned and their own personal applications.

Upon termination of employment, the employer would have to physically retrieve the employer-issued mobile device to the user to remove the employer's applications. Thus, in this instance, at least the former employee would not be able to use the employer's applications.

Embodiments herein deviate with respect to conventional techniques. For example, one embodiment herein includes a novel way of providing remote management and control of applications and/or related resources installed on a computer device.

More specifically, in accordance with one embodiment, an operator or other suitable resource initiates installation of a primary application for execution on a mobile computer device. The primary application can be configured to perform any suitable function. Installation and/or execution of the primary application on the mobile device can include installation of a secondary application such as an agent application on the mobile computer device unbeknownst to the user. For example, in accordance with one embodiment, an agent application can be included in the installation package used to install the primary application on the mobile device. Thus, at a time of installing a primary application, the agent application can be installed to the mobile computer device.

As an alternative to installing the agent application at a time of installing the primary application to the mobile device, the agent application may be installed at a time such as during or in response to execution of the primary application subsequent to installation. For example, in accordance with this latter embodiment, the primary application, when executed, can include code that performs a check whether the agent application is currently installed and/or executing on the mobile device. If the agent application determines that the agent application is currently not installed and/or not currently executing on the mobile device, as desired, the primary application initiates installation and/or execution of the agent application on the mobile computer device.

Thus, if the agent application is not currently installed, execution of the agent application on the mobile device can include installing the agent application on the mobile device in response to receiving the input from the primary application. Some time after installation, if the agent application is not currently executed on the mobile computer device, the primary application on the mobile computer device can initiate execution of the agent application.

As a more specific non-limiting example, assuming that the primary application is already installed on the mobile computer device, note that a user may initiate launching of the primary application by clicking on a corresponding application symbol displayed on a display screen of the computer device. In response to receiving input such as a command from an operator of the mobile device to launch the primary application, the operating system of the mobile device initiates execution of the primary application on the mobile device.

As mentioned, one function of executing the primary application on the mobile device can be to perform a check whether the agent application is currently executing on the mobile device. If it is not currently executing, the primary application generates one or more calls to functions supported by the operating system of the mobile device to launch the secondary application (e.g., the agent application). In response to receiving input from the primary application executing on the mobile device to launch the agent application, the operating system of the mobile device initiates execution of the agent application on the mobile device.

Subsequent to execution of the agent application, the mobile device establishes a communication link between the agent application and a remote resource. Establishing the link can include opening an appropriate socket in a communication interface of the mobile computer device to send and receive communications to a remote resource over a network, a portion of which may be wireless.

In one embodiment, the mobile device receives communications such as control input transmitted from the remote source over the communication link. The control input can be specifically directed to the agent application executing on the mobile computer device. The agent application in the mobile device uses the control input as a basis to control one or more applications and/or functions of the mobile device.

In yet further embodiments, the input from the primary application to install and/or launch the agent application can include one or more appropriate function calls to an operating system of the mobile device to install and/or execute the agent application on the mobile device. Thus, via appropriate function calls to the operating system or other resources on the mobile computer device, the primary application can be configured to install and/or execute the agent application if it is not currently being executed on the mobile device.

As discussed herein, a benefit of ensuring that the agent application is substantially always executing on the mobile computer device is the ability to remotely control the mobile computer device at substantially any time.

In further embodiments, the primary application executed on the mobile device monitors the mobile device to detect which of multiple applications are currently executing on the mobile device. In response to detecting that the agent application is not currently executing on the mobile device, the primary application performs one or more of the followings steps: i) retrieval of the agent application, and ii) installation of the agent application on the mobile device; and iii) execution of the agent application on the mobile device.

As discussed, once up and running on the mobile device, the agent application can generate one or more appropriate function calls to the operating system of the mobile device to control one or more applications on the mobile device in accordance with the control input received from a remote resource over a network.

In one example embodiment, the agent application on the mobile computer device receives control input from a network administrator at the remote resource. The network administrator has control over a group of one or more applications previously installed on the mobile device. By way of a non-limiting example, the applications in the group managed by the network administrator can be employer-owned and controlled applications as opposed to personal applications installed by a respective user of the mobile device. Thus, the agent application can limit a network administrator to controlling only certain applications on the mobile computer device. Embodiments herein can include preventing the network administrator from access and/or controlling personal information (i.e., information not associated with or owned by the employer) on the user's mobile computer device.

Note that each of the agent application itself and/or communication link between the network administrator and the agent application in the mobile device can be persistent such that the agent application and respective link remains active even after termination of execution of the primary application on the mobile device or after the mobile computer device has been depowered or shut down. For example, the user can close all applications on the mobile device and power down the mobile device. The communication link enables the remote resource to control the applications on the mobile device even though the mobile device is depowered.

In accordance with further embodiments, the agent application may be a background process running on the mobile device unbeknownst to the operator of the mobile device. As an example, the agent application may be configured in a way that the agent application does not appear as an available application for execution on a springboard, home screen, desktop, application management tool, etc. Additionally, presence of the agent process (i.e., executed agent application) may not be visible to the operator of the mobile device. In other words, as mentioned, the agent application can be installed and/or executed on the mobile computer device unbeknownst to the operator of the mobile computer device.

In one embodiment, by way of a non-limiting example, the persistent communication link with which to communicate with the agent application may be akin to a VOIP (Voice Over Internet Protocol) or other suitable type of connection enabling the agent application in the mobile device to receive messages from the remote resource as long the mobile device is powered by a battery. That is, in one embodiment, the agent application and link (or portion thereof) can remain active or executing on the mobile device even after termination of execution of the primary application on the mobile device. Thus, certain applications on the mobile computer device can be controlled at substantially any time.

As mentioned, to execute the commands and/or instructions received from the network administrator at the remote resource, the agent application can make appropriate calls to functions supported by the operating system of the mobile computer device. An example of a command issued by the remote resource over the persistent link to the mobile computer device is a delete application command. The delete application command indicates to the agent application to remove or uninstall a specified application on the mobile device.

In such an instance, upon receipt of the delete application command, the agent application performs a set of one or more predetermined calls to functions supported by the operating system to remove or uninstall a particular application or applications on the mobile computer device as specified by the received command. Deletion of the application from the mobile device can include terminating execution of the application and then un-installing the specified application so that it can no longer be used by the user of the mobile computer device.

In accordance with another non-limiting example embodiment, the primary application as discussed herein can be a browser type of application enabling retrieval and/or installation of applications from an on-line application library available to members of a particular organization to which the operator of the mobile computer device belongs. The operator of the mobile device can install the primary application on the mobile computer device for a purpose such as visiting an appropriate website to access an application library of employer-owned applications. As an employee, the user is able to use the primary application to retrieve and install applications from the application library. Thus, the primary application can be a browser providing access to employer-owned applications.

As previously discussed, via commands to the agent application, an authority such as a network administrator appointed by the organization (i.e., employer) can remotely delete applications retrieved and installed from the application library. In other words, in one non-limiting example, the agent application can be configured to limit the remote resource to controlling only applications (or corresponding data) installed onto the mobile device via the primary application. Thus, a user of the mobile computer device need not be concerned about the network administrator accessing their own personal information.

If desired, note that applications installed onto the mobile device using the primary application can be tracked, tagged, labeled, etc., such that the network administrator or other remote control resource is aware which applications on the mobile computer device are employer-owned and which are the user's personal applications.

These and other embodiments are discussed in more detail below.

As mentioned above, note that embodiments herein can include a configuration of one or more computerized devices, workstations, handheld or laptop computers, personal computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the steps and operations as discussed herein. One such embodiment comprises a computer program product including a non-transitory computer-readable storage medium (i.e., any suitable computer readable hardware storage medium) on which software instructions are encoded for subsequent execution. The instructions, when executed in a computerized device having a processor, program and/or cause the processor to perform the operations disclosed herein. Such arrangements are typically provided as software, code, instructions, and/or other data (e.g., data structures) arranged or encoded on a non-transitory computer readable storage medium (i.e., any computer readable hardware storage media) such as an optical medium (e.g., CD-ROM), floppy disk, hard disk, memory stick, etc., or other medium such as firmware or microcode in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, one particular embodiment of the present disclosure is directed to a method and computer program product that includes a computer readable hardware storage medium having instructions stored thereon. For example, in one embodiment, the instructions, when executed by one or more processor devices in a computer system, cause the one or more processor devices to: in response to receiving input from a primary application executing on a mobile device, initiate execution of an agent application on the mobile device; establish a communication link between the agent application and a remote resource; receive control input transmitted from the remote source over the communication link to the agent application; and in accordance with the control input received from the remote resource, control at least one application on the mobile device.

Another particular embodiment of the present disclosure is directed to a method and computer program product that includes a computer readable hardware storage medium having instructions stored thereon. The instructions in such an embodiment, when executed by one or more processor devices in a computer system, cause the one or more processor devices to: install a primary application onto a mobile device; at a time of installing the primary application, installing a secondary application onto the mobile device; via input from the primary application, initiating execution of the secondary application; establishing a communication link between the secondary application and a remote resource over a network; and via input received from the remote resource over the communication link, control a group of at least one application on the mobile device. The ordering of the steps has been added for clarity sake. These steps can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein can be embodied strictly as a software program, as a hybrid of software and hardware, or as hardware alone such as within a processor, or within an operating system or a within a software application.

Additionally, although each of the different features, techniques, configurations, etc., herein may be discussed in different places of this disclosure, it is intended that each of the concepts can be executed independently of each other or, where suitable, the concepts can be used in combination with each other. Accordingly, the one or more present inventions as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), and additional points of novelty, the reader is directed to the Detailed Description section and corresponding figures of the present disclosure as further discussed below.

### BRIEF DESCRIPTION OF THE DRAWINGS

FIG. 1 is an example diagram illustrating remote management of applications on a mobile computer device according to embodiments herein.

FIG. 2 is an example diagram illustrating installation of a primary application according to embodiments herein.

FIG. 3 is an example diagram illustrating installation and execution of agent application on a mobile computer device according to embodiments herein.

FIG. 4 is an example diagram illustrating persistence of an agent application and a corresponding communication link with a remote resource enabling remote control according to embodiments herein.

FIG. 5 is an example diagram illustrating the ability of a remote resource to control a group of one or more applications installed on a mobile device according to embodiments herein.

FIG. 6 is an example diagram illustrating use of a notification network to enable remote control of a group of applications installed on a mobile computer device according to embodiments herein.

FIG. 7 is an example diagram illustrating registration information configuring respective servers in a notification network to facilitate distribution of messages according to embodiments herein. FIG. 8 is an example diagram illustrating an example computer architecture for implementing functionality according to embodiments herein.

FIG. 9 is a flowchart illustrating an example method facilitating control of one or more applications from a remote location according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

According to embodiments herein, a primary application, when executed on a mobile computer device, can include code that performs a check whether an agent application is currently installed and/or executing on a corresponding mobile computer device. If the primary application determines that the agent application is not currently installed and/or not currently executed on the mobile device, as needed, the primary application initiates installation and/or execution of the agent application on the mobile device unbeknownst to the user of the mobile device. The agent application can be a background process that survives (e.g., continues executing) even after termination of execution of the primary application and/or powering down of the mobile computer device. A network administrator or other control entity communicates with the agent application on the mobile device over a persistent communication link to manage a group of one or more applications installed on the mobile device.

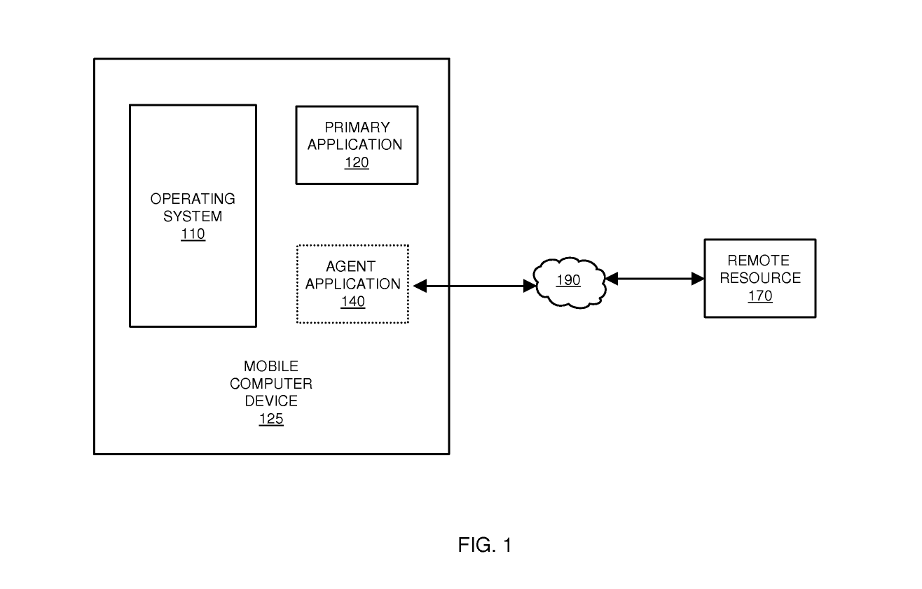

More specifically, FIG. 1 is an example diagram illustrating a mobile computer device according to embodiments herein.

As shown, the mobile computer device 125 such as an iPhone™, iPad™, Blackberry™, Android™, Smartphone™, etc., includes operating system 110. Operating system 110 includes a respective kernel that supports execution of one or more applications installed on the mobile computer device 125.

One application installed on mobile computer device is primary application 120. In general, the primary application 120 can be any application, executable by the user, to perform a respective function.

In one embodiment, when executing, the primary application 120 can be configured to perform a check whether an agent application 140 is currently installed and/or executing on the mobile computer device 125.

If the primary application 120 determines that the agent application 140 is currently installed and/or currently executing on the mobile computer device 125, the primary application 120 need not initiate installation or execution of the agent application 140.

On the other hand, if the primary application 120 determines that the agent application 140 is currently not installed and/or currently executing on the mobile computer device 125, the primary application 120 initiates installation and/or execution of the agent application 140 on the mobile computer device 125. More specifically, if the agent application 140 is not yet installed, the primary application 120 can be configured to initiate installation as well as subsequent execution of the agent application 140. If the agent application 140 is installed but not executing, the primary application 120 can be configured to initiate execution of the agent application 140 via an appropriate command to launch the agent application 140.

In one embodiment, the installation (if not yet installed) and/or execution (if not yet executed) of the agent application 140 is performed unbeknownst to the user of the mobile computer device 125. For example, the primary application 120 can be configured to install and/or execute the agent application 140 without providing notification to the operator of the mobile computer device 125 that the agent application 140 is being installed/executed.

As discussed herein, subsequent to execution of the agent application 140, a remote resource 170 can control one or more applications installed on the mobile computer device 125. For example, in one embodiment, the remote resource 170 communicates over network 190 with the agent application 140 over a respective communication link (e.g., between the agent application 140 and the remote resource 170) to control one or more different aspects of the mobile computer device 125. More specifically, in accordance with one non-limiting example, the agent application 140 executed on the mobile device 125 enables the remote resource 170 to manage a group of one or more applications and/or related information on the mobile computer device 125.

Any portion of the communication link between the agent application 140 and the remote resource over network 190 can be wireless, hard-wired, etc.

By way of further non-limiting example, note that the agent application 140 can be a daemon (e.g., computer program) that runs as a background process, rather than a process under the direct control of an interactive user or operator of the mobile computer device 125.

As further discussed herein, by way of a non-limiting example, via the primary application 120 executed on the mobile computer device 125, the mobile computer device 125 can retrieve and install one or more available applications. As an example, the primary application 120 can be a browser type application enabling a respective user of the mobile computer device 125 to view available applications in an application library over a network. The user of the mobile computer device 125 may have access to the application library because he is a member of an organization. The primary application 120 (such as a browser application) can enable the user to retrieve and subsequently install one or more applications available from the application library using respective browser capability.

Via a communication link between the agent application 140 and the remote resource 170, assume that the mobile computer device 125 receives a delete command from the remote resource 170 indicating to uninstall or delete a specified application that was previously installed on the mobile computer device 125 via use of the primary application 120. In such this instance, the agent application 140 executes the delete command by terminating the specified application and then removing the particular application from the mobile computer device 125. The agent application 140 can execute the delete command by initiating execution of one or more appropriate low level function calls to the operating system 110.

Note that the primary application 120 (or other resource checking whether the agent application 140 is currently executing) may also check the version of the agent application 140 executing on the mobile computer device 125. If a newer version of the agent is available, as detected by the primary application 120 or other suitable resource, the primary application 120 can initiate retrieval, installation, and execution of the updated version of the agent application 140 on the mobile computer device 125.

Note further that installation of the agent application 140 can include registering the agent application 140 for execution each time the mobile computer device 125 is rebooted. For example, upon each power up of the mobile computer device, the boot program for initializing the mobile computer device 125 can include a call to execute the agent application 140 during a boot of the mobile computer device 125. As discussed herein, checks to determine whether the agent application 140 is executing can be performed at other times as well.

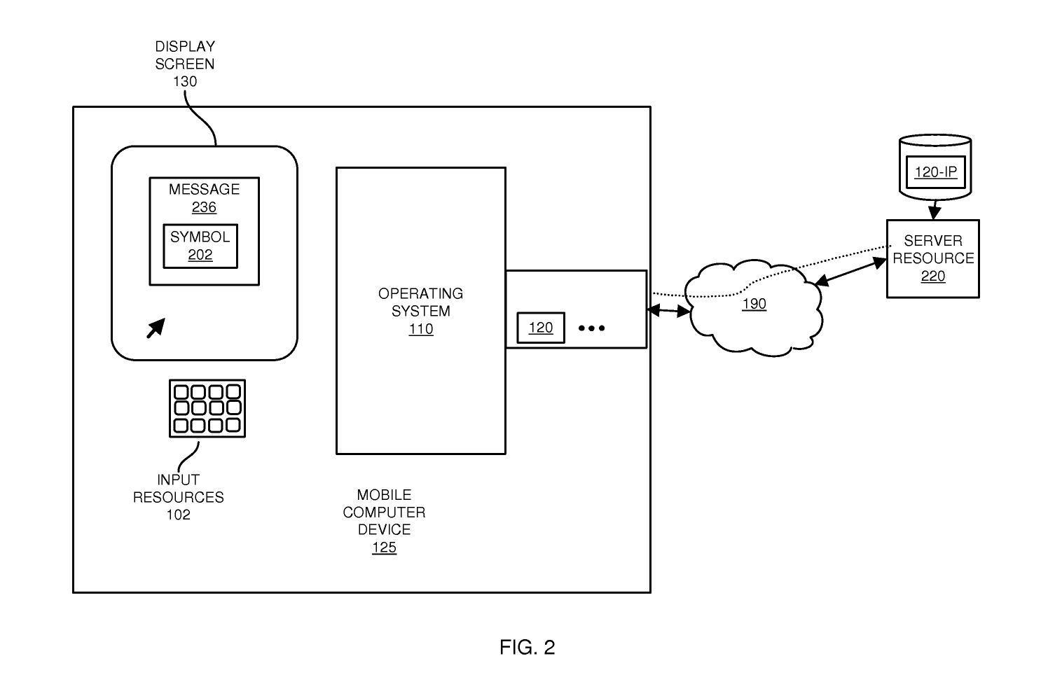

FIG. 2 is an example diagram illustrating a mobile computer device according to embodiments herein.

As shown, input resources 102 enable a respective user to provide input to control the mobile computer device 125. Mobile computer device 125 includes display screen 130 to display information to a respective user.

Assume in this example, that the operator of mobile computer device 125 is a member of an organization. Because the user is a member of the organization, the operator receives a message 236 such as an e-mail including a link (e.g., as represented by symbol 202) to a website from which the primary application 120 can be retrieved and subsequently installed on the mobile computer device 125.

In this example, as mentioned, assume that the primary application 120 enables viewing of applications in a remote application library accessible by the operator of the mobile computer device 125 because he is a member of an organization. By way of a non-limiting example, the primary application 120 (e.g., a browser like application) enables retrieval and installation of applications from the application library to the mobile computer device 125. In other words, because the user of the mobile computer device 125 is a member of an organization, the user can have access to certain employer-owned applications in the application library.

Assume that the user selects symbol 202 to install the primary application 120 onto the mobile computer device 120. Subsequent to selection of the symbol 202 (e.g., a hyperlink) in the message 236 to install the primary application 120 via installation package 120-IP, the mobile computer device 125 initiates communications with the server resource 220 as specified by the link. Via communications over network 190 with server resource 220, the mobile computer device 125 retrieves installation package 120-IP.

Assume further in the example embodiment that the operator of the mobile computer device 125 uses the installation package 120-IP to install the primary application 120 onto the mobile computer device 125. For example, in response to receiving a further command from the operator of the mobile computer device 125 to install the primary application 120 on the mobile device 125, the mobile computer device 125 (and/or respective operating system 110) uses the installation package 120-IP retrieved over network 190 to install the primary application 120 onto the mobile computer device 125. Subsequent to installation, the primary application 120 is available for execution by the user of the mobile computer device 125 to retrieve and install applications from an application library accessible by primary application 120.

Note that the agent application 140 can be installed on the mobile computer device 125 at a same time of installing the primary application 120. That is, installation package 120-IP can support installation of the both the primary application 120 and the agent application 140 (i.e., a secondary application). The agent application 140 can be executed on the mobile computer device 125 via a launch command generated by the primary application 120.

In other embodiments, the agent application 140 can be installed at a time of executing the primary application 120. In other words, the primary application 120 can initiate installation of the agent application 140 from installation package 120-IP or other suitable resource.

As previously discussed, in one embodiment, the primary application 120 (when executed) can enable the user of the mobile computer device 125 to view, retrieve, and install applications associated with the organization to which the user belongs. For example, the primary application 120 can be a browser type application enabling a respective user to visit an appropriate web site and browse a catalog of applications that are available for retrieval and installation to the user's mobile computer device 125 because the user is a member of a particular organization.

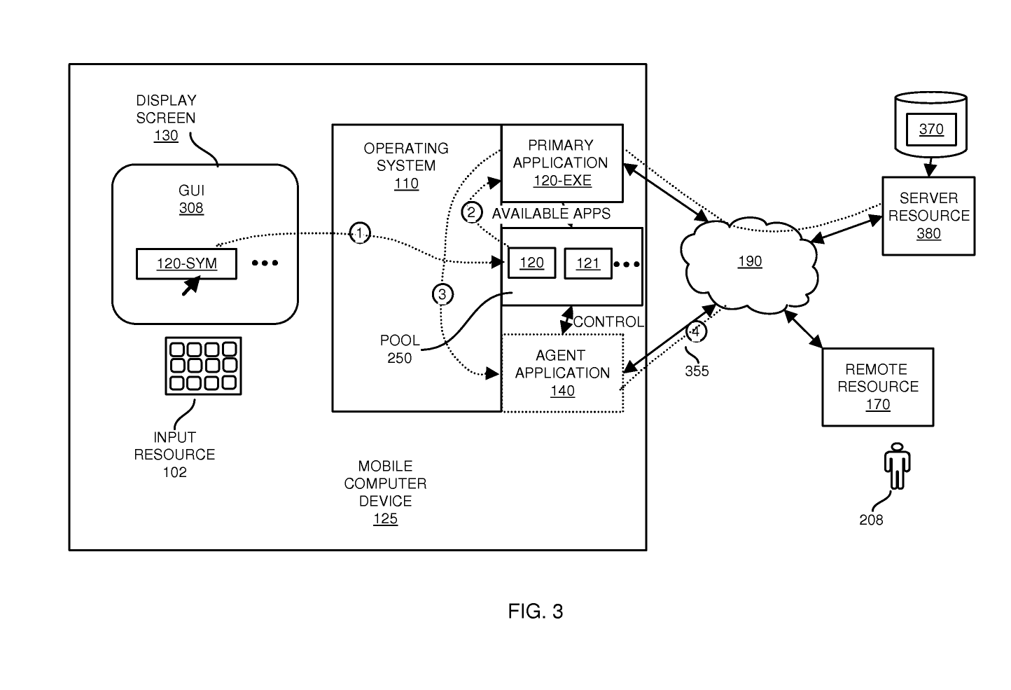

FIG. 3 is an example diagram illustrating retrieval, installation, and execution of an agent application according to embodiments herein.

In this example, the user of mobile computer device 125 views graphical user interface 308 such as a home screen, desktop, etc., of mobile computer device 125 to view the different applications that are available for execution by the mobile computer device 125. Recall that primary application 120 was previously installed on the mobile computer device 125 and is therefore available for execution.

As shown, the graphical user interface 308 includes a display of symbol 120-SYM, etc. Each symbol represents an application installed on the mobile computer device 125. In this example, assume that symbol 120-SYM is a selectable icon corresponding to the primary application 120. Selection of the symbol 120-SYM by the user of mobile computer device 108 launches the primary application 120.

In response to selection of the symbol 120-SYM, the operating system 110 receives the selection command and initiates execution of the primary application 120.

In this example, primary application 120-EXE represents the currently executing version of the primary application 120.

As mentioned, in one non-limiting example embodiment, via the primary application 120-EXE, the user of the mobile computer device 125 is able to retrieve and install applications from an application library to the mobile computer device 125. For example, the primary application 120 can be used to communicate over network 190 with server resource 380 to retrieve and/or install available applications 370.

As mentioned, the primary application 120-EXE can include code that performs a check whether a respective agent application 140 is installed and/or executing on the mobile computer device 125. The check can include first taking an inventory of any or all processes currently executing on the mobile computer device 125 and determining if the agent application 140 is presently executed.

If the primary application 120-EXE determines that the agent application 140 is currently not installed on the mobile computer device 125, via one or more appropriate function calls to the operating system 110, the primary application 120-EXE can initiate installation of the agent application 140 onto the mobile computer device 125 as well as subsequent execution of the agent application 140.

If the primary application 120-EXE detects that the agent application 14 is already installed on the mobile computer device 125, but is not currently executing, then the primary application 120-EXE merely initiates execution of the agent application 140 on the mobile computer device 125.

Thus, as previously mentioned, the agent application 140 can be installed at a time of installing the primary application 120. Alternatively, the agent application 140 can be installed at a time of executing the primary application 120-EXE.

Subsequent to execution of the agent application 140 on the mobile computer device 125, and on behalf of the agent application 140, the mobile computer device 125 establishes a communication link 355 with at least one server in network 190 to facilitate retrieval of input from remote resource 170 or other suitable resource having the authority to control the applications on the mobile computer device 125.

In further embodiments, by way of a non-limiting example, the communication link 355 is persistent, akin to a VOIP (Voice Over Internet Protocol) or other suitable type of connection enabling the agent application 140 in the mobile device 125 to receive and transmit messages to the remote resource 170 as long the mobile computer device 125 is powered by a battery. That is, in one embodiment, the agent application 140 remains executing on the mobile computer device 125 even after termination of execution of the primary application 120-EXE on the mobile computer device 125.

Establishing the communication link 355 can include opening an appropriate HTTP (Hypertext Transfer Protocol) type communication socket in the mobile computer device 125. In one embodiment, the socket associated with communication link 355 is established based at least in part on the HTTP protocol (e.g., via an upgrade header in which value=websocket). Communications between endpoints (e.g., the agent application 140 and the remote resource 170) can be TCP/IP (Transmission Control Protocol/Internet Protocol) or other suitable type of data packets, messages, etc.

Assume in this example that the mobile computer device 125 receives, over communication link 355, control input transmitted from network administrator 208 at the remote source 170. The control input such as a message can include routing or address information to deliver the control input to the agent application 140 executing on the mobile computer device 125. Remote resource 170 can be a computer device used by the network administrator 208 to manage and/or control one or more applications installed on the mobile computer device 125.

In accordance with the control input received over communication link 355 from a network administrator 208 at the remote resource 170, the agent application 140 generates one or more appropriate function calls to the operating system 110 of the mobile computer device 125 to control one or more applications on the mobile computer device 125.

Note that in one embodiment, the agent application 140 can communicate in a reverse direction back to the remote resource 170. For example, if desired, the agent application 140 can occasionally send keep-alive messages to the remote resource 170 to notify the remote resource 170 that the communication link 355 is still functional. Thus, the communication link 355 can be bi-directional.

Note additionally that the agent application 140 in the mobile computer device 125 can be persistent. For example, the user can close or terminate all currently executing applications on the mobile computer device 125 and/or power down the mobile computer device 125. The communication link 355 (or portion thereof) between the agent application 140 and network 190 or the remote resource 170 can remain active even after termination of execution of the primary application 120-EXE or after the mobile computer device 125 is powered down.

Also, as previously mentioned, the agent application 140 can be a background process such as a daemon running on the mobile computer device 125 unbeknownst to the operator of the mobile computer device 125. As an example, the agent application 140 may be configured in a way that the agent application 140 does not appear as an available application in a home screen or desktop for execution.

Additionally, the fact that the agent process 140 is currently executing on the mobile computer device 125 may not be visible to the operator of the mobile computer device 125. Thus, a user of the mobile computer device 125 may not be able to (easily) disable or terminate execution of the agent application 140.

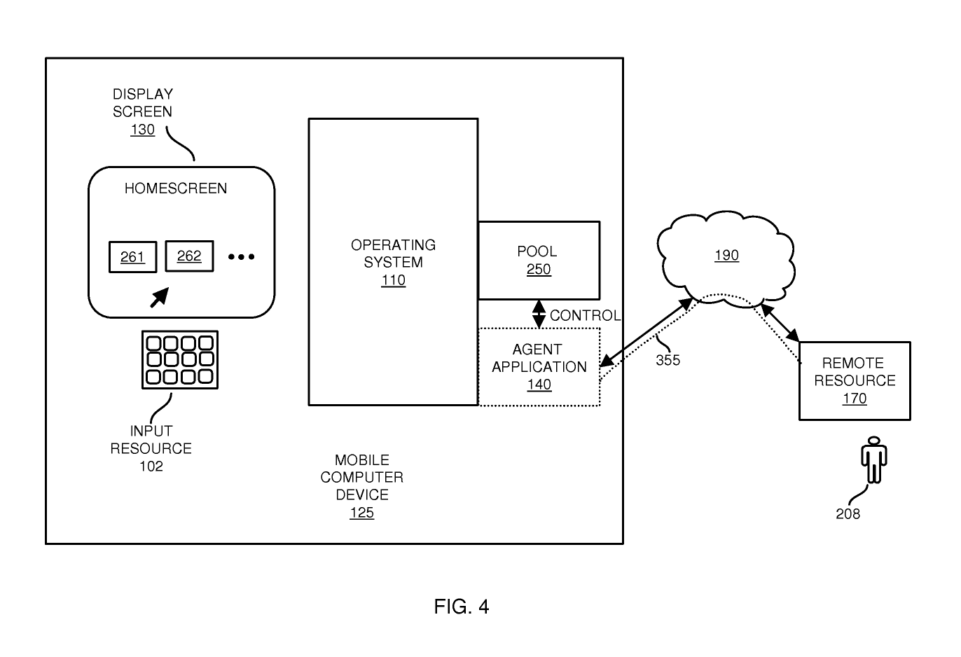

FIG. 4 is an example diagram illustrating persistence of the agent application and/or communication link after termination of the installation manager application according to embodiments herein.

As shown in this further example embodiment, assume that the user terminates execution of the primary application 120-EXE. Termination of the primary application 120-EXE can occur in response to receiving appropriate input from any suitable resource such as a respective user of the mobile computer device 125 or even network administrator 208.

The agent application 140 remains actively executing of the mobile computer device 125 even after termination of execution of the primary application 120-EXE. Accordingly, the network administrator 208 at remote resource 170 can continue to provide input to control mobile computer device 125 even though the primary application 120 (and/or other applications on the mobile computer device 125) has been terminated.

To conserve on battery power, the agent application 140 can be set to a standby mode until a message is received from the remote resource 170 to perform a respective action such as delete a previously installed application from the mobile computer device.

As mentioned, if desired, the remote resource 170 can be limited to controlling applications in pool 250 such as those applications installed on the mobile computer device 125 using the primary application 120. Other embodiments include enabling the network administrator 208 to control only applications and/or respective data that are made available for use by the organization.

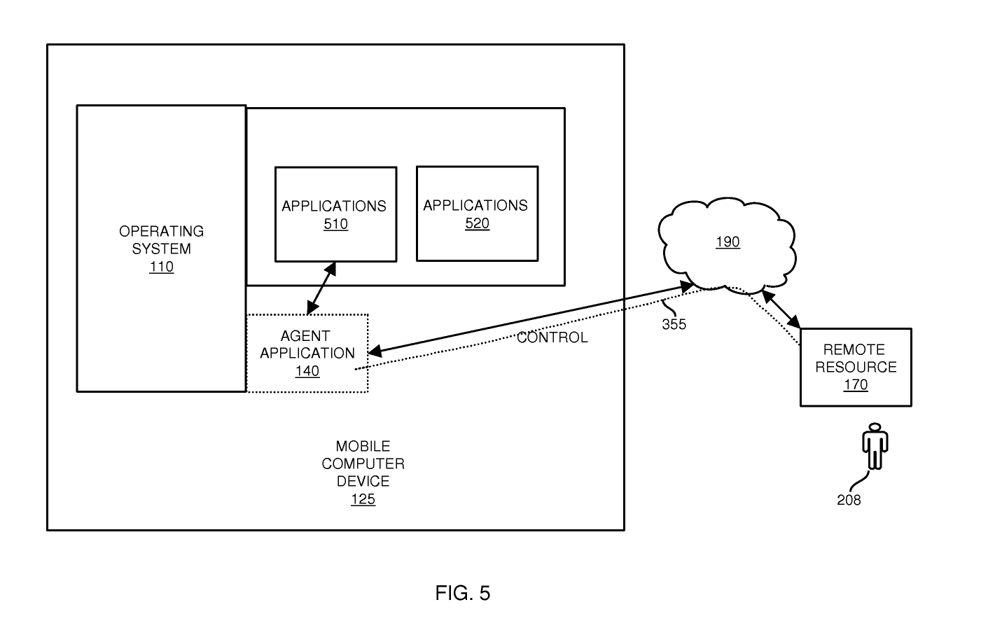

FIG. 5 is an example diagram illustrating a group of one or more applications that can be managed by a remote resource according to embodiments herein.

As previously discussed, in accordance with one non-limiting example embodiment, the primary application 120-EXE enables retrieval and installation of applications due to membership of the user in a respective organization. The group of applications 510 represents applications installed by the user onto the mobile computer device 125 using primary application 120-EXE or applications that are made available to the user of the mobile computer device 125 because he is a member of an organization.

Note that mobile computer device 125 can include group of applications 520 such as personal applications installed onto the mobile computer device 125 via a resource other than the primary application 120-EXE. In other words, the applications 520 represent applications installed on the mobile computer device 125 for personal use by the user of mobile computer device 125.

In one embodiment, the network administrator 208 has control only over the group of applications 510 installed on the mobile computer device 125 via the primary application 120-EXE. In other words, in accordance with one embodiment, the agent application 140, remote resource 170, etc., can be configured to limit the network administrator 208 at the remote resource 170 to controlling only applications installed on the mobile computer device 125 via use of the primary application 120-EXE as previously discussed. Thus, the user is free to use his own personal applications 520 regardless of input provided by the network administrator 208 as such personal applications and information cannot be deleted or controlled by network administrator 208.

If desired, applications installed on the mobile computer device 125 using the primary application 120-EXE can include identifier information such as a unique tag, identifier value, etc., such that it is apparent which applications are personal applications versus which applications are employer owned. The identifier information can be stored in any suitable registry.

By further way of a non-limiting example, via the identifier information, the remote resource 170 and/or mobile computer device 125 communicating with the mobile computer device 125 and/or the agent application 140 is able to identify which applications belong to a group of one or more applications on the mobile computer device 125 that can be managed by the remote resource 170. Any other suitable technique can be used to prevent the remote resource 170 from controlling the user's personal applications and data on the mobile computer device 125.

An example of a command issued by the network administrator 208 at the remote resource 170 is a delete application command. The network administrator 208 can issue the delete application command to initiate removal or un-installation of a particular application on the mobile computer device 125. The remote resource 170 receives the command and communicates it over communication link 355 to the agent application 140.

Upon receipt of the delete application command, the agent application performs a set of one or more predetermined calls to functions supported by the operating system 110 to terminate and/or remove (i.e., uninstall) a particular application or applications as specified by the command generated by the network administrator 208.

In one embodiment, subsequent to termination and deletion of the application, the agent application 140 provides notification back to the network administrator 208 at the remote resource indicating that the application has been deleted.

In this way, the network administrator 208 is able to control applications in group of applications 510.

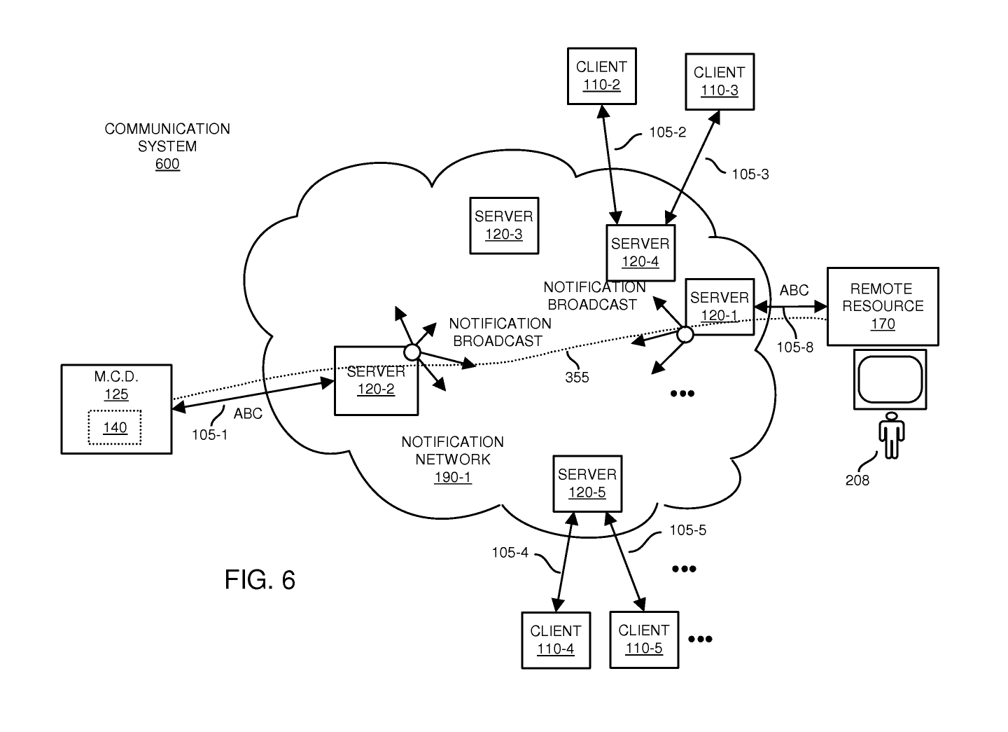

FIG. 6 is an example diagram illustrating a notification network facilitating distribution of messages according to embodiments herein.

In one embodiment, each of the servers 120 (e.g., server 120-1, server 120-2, server 120-3, etc.) or other suitable resources maintains registry information indicating clients that have joined as participants in the different communications sessions.

Initially, the mobile computer device 125 can establish a connection with server 120-2 to create a persistent communication link. Because no other resources are connected to notification network 190-1 to communicate over communication session ABC, the agent application 140 does not receive any communications to control applications on the mobile computer device 125. As shown and as further discussed below, the remote resource 170 can subsequently join communication session ABC to communicate over notification network 190-1 to control the mobile computer device 125.

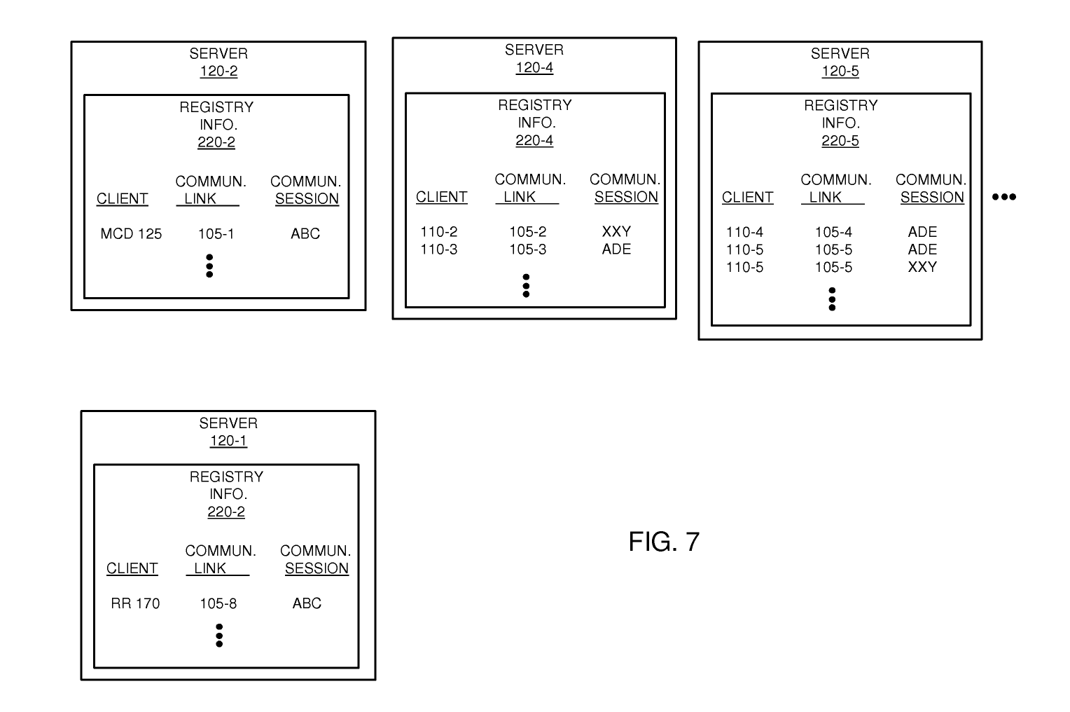

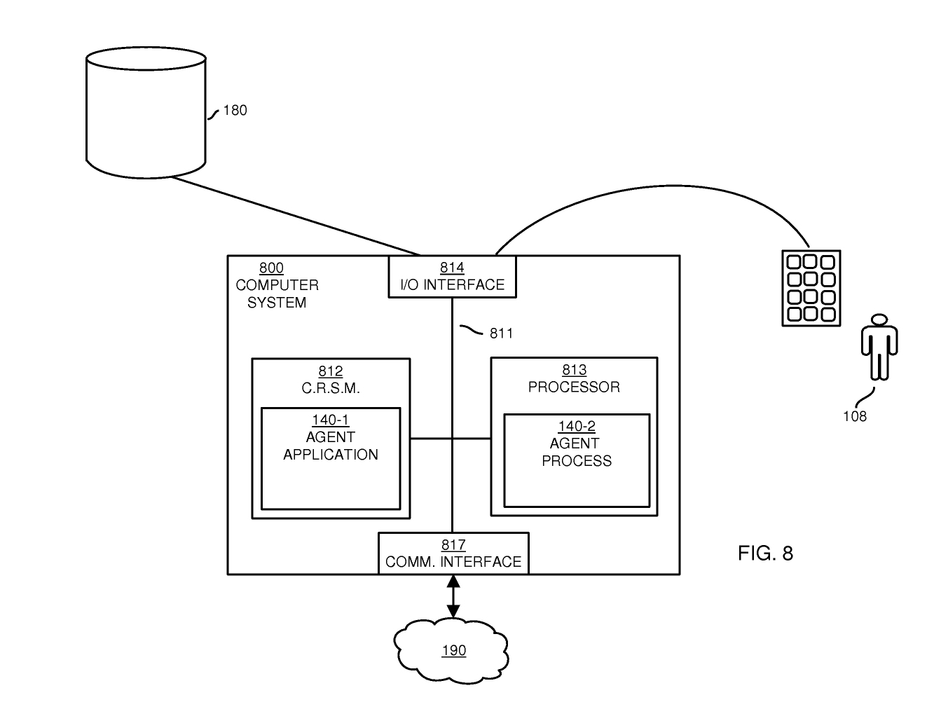

FIG. 7 is an example diagram illustrating of registry information used to configure the notification network in FIG. 6 according to embodiments herein. As shown, registry information 220-1 associated with server 120-1 and registry information 220-2 associated with server 120-2 indicate that both the mobile computer device 125 and the remote resource 170 are the only participants in communication session ABC after the remote resource joins communication session ABC.

Registry information 220-4 associated with server 120-4 indicates that the communication link 105-2 between client 110-2 and the server 120-4 supports communication session XXY and that the communication link 105-3 between client 110-3 and the server 120-4 supports communication session ADE.

Registry information 220-5 associated with server 120-5 indicates that the communication link 105-4 between client 110-4 and the server 120-5 supports communication session ADE. Registry information 220-5 also indicates that the communication link 105-5 between client 110-5 and the server 120-5 supports communication sessions ADE and XXY.

Referring again to FIG. 6, in one embodiment, the servers 120 communicate with each other via broadcasting or multi-casting of notification messages to other servers 120 in the notification network 180 regardless of whether a respective server in the notification network 180 has any clients registered to participate in the communication session. Thus, all of the servers in notification network 190 can be configured to receive a broadcasted message form another server. However, only certain servers forward the received broadcasted message to a respective client depending on whether the respective clients are members of a respective communication session to which the message is directed.

For example, a network administrator 208 at the remote resource 170 can generate and transmit message (e.g., control information) over communication link 105-8. The server 120-1 receives the message generated by the remote resource 170. The message can be tagged with information indicating that the message belongs to communication session ABC.

Server 120-1 broadcasts the message received from remote resource 170 to each of the other servers in notification network 190-1. Server 120-2 (amongst other servers in notification network 190-1) receives the broadcasted message and detects that the broadcasted message belongs to communication session ABC.

Based on registry information 220-2, the server 120-2 detects that the mobile computer device 125 is a member of communication session ABC. The server 120-2 then forwards the received message to the mobile computer device 125. The other servers in notification network 190-1 receive the message and do not forward the message to respective clients 110 because they are not members of communication session ABC.

In a reverse direction, the mobile computer device 125 can communicate with the remote resource 170. For example, assume that the server 120-2 receives a message directed to (e.g., via a tag ABC) remote resource 170 from the agent application 140 over communication link 105-1. The agent application 140 can tag the with information to indicate that the message belongs to communication session ABC. The server 120-2 broadcasts the message received from the mobile computer device 125 to each of the other servers in notification network 190-1.

Server 120-1 receives the broadcasted message and detects that the message belongs to communication session ABC. Based on registry information 220-1, the server 120-1 knows that remote resource 170 is a member of the communication session ABC. Accordingly, the server 120-1 forwards the received message to the remote resource 170.

Other servers receiving the messages for communication session ABC do not forward the message to their clients 110-2, 110-3, 110-4, 110-5, etc., because the message from the agent application 140 mobile computer device 125 is not directed to such destinations. That is, the registry information 220 indicates that such clients are not members of communication session ABC.

Note that additional details of notification network 190-1 can be found in earlier filed U.S. Provisional Patent Application Ser. No. 61/540,218 entitled “Multi-Party Communication Sessions via Broadcast Notification Network,” (Attorney

Docket No. APP11-02p), filed on Sep. 28, 2011, the entire teachings of which are incorporated herein by this reference.

In contrast to conventional techniques, the notification system and related techniques as discussed herein enables each of one or more clients to set up a persistent bi-directional link on which to receive and transmit messages from the server without having to repeatedly set up and tear down web connections. Additionally, in one embodiment, the persistent link allows clients to send and receive messages without being hindered by the presence of a corporate firewall, which may otherwise restrict inbound communications to the clients.

In certain cases, it is possible that a respective communication link such as communication link 105-1 is temporarily down. For example, a user may be in a location in which the mobile computer device 125 does not have immediate access to server 120-2. In other words, the agent application 140 temporarily may not be able to communicate with the server 120-2. In such an instance, the mobile computer device 125 may not be able to receive messages from server 120-2. One embodiment herein includes buffering messages in server 120-2 or other suitable resource in the event that the communication link 105-1 can't be used to transmit information from the server 120-2 to the mobile computer device 125.

Subsequent to a link 105-1 being available again, the server 120-2 can be configured to communicate the buffered messages to the mobile computer device 125. Thus, a socket in the mobile computer device 125 supporting communications with server 120-2 may not be terminated even though it is temporarily not possible to communicate over communication link 105-1.

In a similar manner, the mobile computer device 125 can buffer messages intended for transmission to the server 120-2. Subsequent to a link 105-1 being available again, the mobile computer device 125 communicates the buffered messages to the server 120-2 for further distribution in notification network to one or more appropriate destinations.

As previously discussed, the communication link 105-1 may be persistent. That is, communication link 105-1 can be maintained as being active even though no other resource in communication system 600 is connected to the notification network 190-1 to communicate with the mobile computer device 125 through the communication link 105-1.

Maintaining the communication link 105-1 as a persistently active link enables control of the mobile computer device 125 at any time. As an example, assume that the mobile computer device 125 installs and/or executes the agent application 140 in a manner as previously discussed. Creation of the communication link 105-1 and communication session ABC can include registering with server 120-2 as well as an access manager associated with the notification network 190-1. In one embodiment, the access manager in communication system 600 keeps track of the presence/availability of the communication link 105-1.

Assume in this example that the there is currently only a persistent communication link 105-1 between the agent application 140 and the server 120-2 and that no other parties have joined the communication session ABC yet.

To join the communication session ABC and communicate with the mobile computer device 125, and possibly control it as discussed herein, the remote resource 170 can send a message to the access manager requesting to establish a connection with the mobile computer device 125. In such an instance, prior to providing information enabling access, the access manager associated with notification network 190-1 may request that the remote resource 170 and/or network administrator 208 provide appropriate credentials indicating that network administrator 208 and/or remote resource 170 is authorized to communicate with the agent application 140 on the mobile computer device 125. If network administrator 170 provides proper access credentials to the access manager, the access manager initiates creation of communication link 105-8 enabling remote resource 170 to communicate with the mobile computer device 125 and control it via communication over communication session ABC. Because the communication link 105-1 is persistent, via communications with the agent application 140, the network administrator 208 can have access and respective control of the mobile computer device 125 at substantially all times, even if the mobile computer device 125 is not powered.

Note that the agent application 140 may require that the remote resource 170 provide further authorization information prior to allowing the network administrator 208 to control the mobile computer device 125.

Thus, because the communication link 105-1 is persistent, the remote resource 170 (or any other resource having authorization) can connect and communicate with the agent application 140 in mobile computer device 125.

FIG. 8 is an example block diagram of a computer hardware system for executing operations according to embodiments herein. Any of the functionality and/or resources as discussed herein can be executed with computer system 800 or the like to perform functionality as discussed herein.

Computer system 800 (e.g., computer hardware, software, etc.) can be or include one or more computerized devices such as a mobile computer device, personal computer, workstation, portable computing device, mobile device, handheld device, console, network terminal, processing device, network device, etc.

Note that the following discussion provides a basic embodiment indicating how to execute functionality according to embodiments herein using a computer system. However, it should be noted that the actual configuration for carrying out the operations as described herein can vary depending on a respective application.

As shown, computer system 800 of the present example includes an interconnect 811 that couples computer readable hardware storage media 812 (i.e., a non-transitory type of computer readable storage media) in which digital information can be stored and/or retrieved, a processor device 813, I/O interface 814, a communications interface 817, etc.

I/O interface 814 provides connectivity to different resources such as a repository, display screen, keyboard, computer mouse, etc.

Computer readable storage medium (or media) 812 can be any suitable device, resource, combination of resources, including one or more components such as memory, optical storage, hard drive, floppy disk, etc. In one embodiment, the computer readable storage medium 812 is a non-transitory computer readable storage media (e.g., any hardware storage media) to store instructions and/or data.

Communications interface 817 enables the computer system 800 and processor device 813 to communicate over a network 190 to retrieve information from remote sources and communicate with other computers. I/O interface 814 enables processor device 813 to retrieve respective information from a repository.

As shown, computer readable storage media 812 can be encoded with agent application 140-1 (e.g., software, firmware, etc.) executed by processor 813.

During operation of one embodiment, processor device 813 (e.g., one or more computer devices) accesses computer readable storage media 812 via the use of interconnect 811 in order to launch, run, execute, interpret or otherwise perform the instructions of, for example, agent application 140-1 stored on computer readable storage medium 812. Agent application 140-1 can include appropriate instructions, logic, etc., to carry out any or all functionality associated with the resources (e.g., clients, servers, notification network, network administrator, etc.) in a computer network environment as discussed herein.

Execution of the agent application 140-1 produces processing functionality such as agent process 140-2 in processor device 813. In other words, the agent process 140-2 associated with processor device 813 represents one or more aspects of executing agent application 140-1 within or upon the processor device 813 in the computer system 800.

Those skilled in the art will understand that the computer system 800 can include other processes and/or software and hardware components, such as an operating system that controls allocation and use of hardware resources to execute agent application 140-1.

In accordance with different embodiments, note that the computer system may be any of various types of devices, including, but not limited to, a personal computer system, desktop computer, laptop, notebook, netbook computer, mainframe computer system, handheld computer, workstation, network computer, application server, storage device, a consumer electronics device such as a camera, camcorder, set top box, mobile device, portable handheld device, video game console, handheld video game device, a peripheral device such as a switch, modem, router, or in general any type of computing or electronic device.

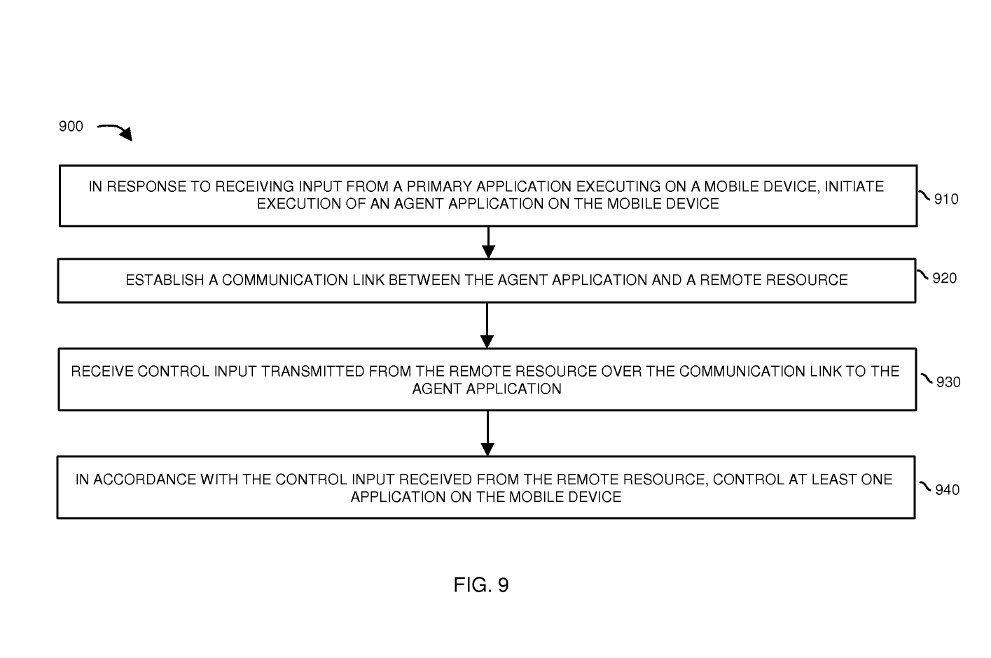

Functionality supported by resources in network environment and resources therein will now be discussed via flowcharts in FIG. 9. Note that there will be some overlap with respect to concepts discussed above for FIGS. 1 through 8. Also, note that the steps in the below flowcharts need not always be executed in the order shown. That is, the steps can be executed in any suitable order.

FIG. 9 is a flowchart 900 illustrating a method facilitating remote management of a mobile computer device according to embodiments herein.

In step 910, in response to receiving input from primary application 120 executed on mobile computer device 125, the primary application 120 of mobile computer device 125 initiates execution of agent application 140.

In step 920, the mobile computer device 125 establishes a communication link 355 between the agent application 140 and remote resource 170.

In step 930, the mobile computer device 125 receives control input transmitted from the remote resource 170 over the communication link 355 to the agent application 140.

In step 940, in accordance with the control input received from the remote resource 170, the agent application 140 of mobile computer device 125 initiates commands to operating system 110 to control at least one application on the mobile computer device 125.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
in response to receiving input from a primary application executing on a mobile device, initiating execution of an agent application on the mobile device;
establishing a communication link between the agent application and a remote resource;
receiving control input transmitted from the remote resource over the communication link to the agent application; and
in accordance with the control input received from the remote resource, controlling at least one application on the mobile device.

2. The method as in claim 1, wherein the input from the primary application includes at least one function call to an operating system of the mobile device to execute the agent application on the mobile device.

3. The method as in claim 2, wherein the agent application generates at least one function call to the operating system of the mobile device to control at least one application on the mobile device in accordance with the control input received from the remote resource.

4. The method as in claim 1, wherein initiating execution of the agent application on the mobile device includes installing the agent application on the mobile device in response to receiving the input from the primary application.

5. The method as in claim 1 further comprising:
initiating installation of the primary application on the mobile device in response to receiving a command from an operator of the mobile device to install the primary application on the mobile device.

6. The method as in claim 1 further comprising:
initiating execution of the primary application on the mobile device in response to receiving a command from an operator of the mobile device to launch the primary application.

7. The method as in claim 1, wherein the primary application is a browsing application executed on the mobile device to view applications available for installation on the mobile device.

8. The method as in claim 7, wherein the agent application enables the remote resource to control a group of applications installed onto the mobile device through use of the primary application.

9. The method as in claim 1 further comprising:
establishing at least a portion of the communication link between the agent application and the remote resource to be a persistent link that remains active even after termination of execution of the primary application on the mobile device.

10. The method as in claim 9, wherein the agent application limits the remote resource to controlling only applications installed on the mobile device via the primary application.

11. The method as in claim 1 further comprising:
installing and executing the agent application on the mobile device unbeknownst to an operator of the mobile device that initiates launching of the primary application.

12. The method as in claim 1, wherein the agent application remains active on the mobile device even after termination of execution of the primary application on the mobile device.

13. The method as in claim 9 further comprising:
via the primary application executed on the mobile device, retrieving and installing a particular application to the mobile device;
terminating execution of the primary application on the mobile device in accordance with input from an operator of the mobile device;
via the persistent communication link, receive a delete command from the remote resource to remove the particular application from the mobile device; and
removing the particular application from the mobile device in accordance with the delete command.

14. The method as in claim 1, wherein initiating execution of the agent application on the mobile device includes:
via the primary application executed on the mobile device:
monitoring the mobile device to detect an inventory of applications currently executed on the mobile device; and
in response to detecting that the agent application is currently not executed on the mobile device, initiating execution of the agent application.

15. A computer hardware system comprising:
at least one processor device;
a hardware repository that stores instructions associated with an application executed by the at least one processor; and
an interconnect coupling the processor and the hardware repository, the interconnect causing the at least one process device to execute the application and perform operations of:
initiating execution of a primary application on a mobile device in response to receiving a command to launch the primary application;
initiating execution of an agent application on the mobile device in response to receiving a command from the primary application;
establishing a communication link between the agent application and a remote resource; and
via input received from the remote resource over the communication link, controlling a group of at least one application on the mobile device.

16. The computer hardware system as in claim 15, wherein the input from the primary application includes at least one function call to an operating system of the mobile device to execute the agent application on the mobile device.

17. The computer hardware system as in claim 16, wherein the agent application generates at least one function call to the operating system of the mobile device to control the at least one application on the mobile device in accordance with the control input received from the remote resource.

18. The computer hardware system as in claim 15, wherein initiating execution of the agent application on the mobile device includes installing the agent application on the mobile device in response to receiving the input from the primary application.

19. The computer hardware system as in claim 15, wherein the at least one processor device further supports operations of:
initiating installation of the primary application on the mobile device in response to receiving a command from an operator of the mobile device to install the primary application on the mobile device.

20. The computer hardware system as in claim 15, wherein the at least one processor device further supports operations of:
initiating execution of the primary application on the mobile device in response to receiving a command from an operator of the mobile device to launch the primary application.

21. The computer hardware system as in claim 15, wherein the primary application is a browsing application executed on the mobile device to view applications available for installation on the mobile device.

22. The computer hardware system as in claim 21, wherein the agent application enables the remote resource to control a group of applications installed to the mobile device through use of the primary application.

23. The computer hardware system as in claim 15, wherein the at least one processor device further supports operations of:
establishing the communication link between the agent application and the remote resource to be a persistent link that remains active even after termination of execution of the primary application on the mobile device.

24. The computer hardware system as in claim 23, wherein the agent application limits the remote resource to controlling only applications installed on the mobile device via the primary application.

25. The computer hardware system as in claim 15, wherein the at least one processor device further supports operations of:
installing and executing the agent application on the mobile device unbeknownst to an operator of the mobile device that initiates launching of the primary application.

26. The computer hardware system as in claim 15, wherein the agent application remains active on the mobile device even after termination of execution of the primary application on the mobile device.

27. The computer hardware system as in claim 23, wherein the at least one processor device further supports operations of:
via the primary application executed on the mobile device, retrieving and installing a particular application onto the mobile device;
terminating execution of the primary application on the mobile device in accordance with input from an operator of the mobile device;
via the persistent communication link, receive a delete command from the remote resource to uninstall the particular application from the mobile device; and
removing the particular application from the mobile device in accordance with the delete command.

28. The computer hardware system as in claim 15, wherein initiating execution of the agent application on the mobile device includes:
via the primary application executed on the mobile device:
monitoring the mobile device to detect an inventory of applications currently executed on the mobile device; and
in response to detecting that the agent application is currently not executed on the mobile device: i) retrieving the agent application, and ii) installing the agent application on the mobile device; and iii) executing the installed agent application.

29. A computer-readable hardware storage medium having instructions stored thereon for processing data information, such that the instructions, when carried out by at least one processing device, cause the at least one processing device to perform operations of:
in response to receiving input from a primary application executing on a mobile device, initiating execution of an agent application on the mobile device;
establishing a communication link between the agent application and a remote resource;
receiving control input transmitted from the remote resource over the communication link to the agent application; and
in accordance with the control input received from the remote resource, controlling at least one application on the mobile device.

30. A method comprising:
installing a primary application onto a mobile device via an installation package;
installing a secondary application onto the mobile device via the installation package;
via input from the primary application, initiating execution of the secondary application;
establishing a communication link between the secondary application and a remote resource over a network; and
via input received from the remote resource over the communication link, control a group of at least one application on the mobile device.
